(19) United States
(12) Patent Application Publication
(10) Pub. No.: US 2015/0188342 A1
(43) Pub. Date: Jul. 2, 2015

(54) CHARGER STRUCTURE WITH MULTIPLE FUNCTIONS

(71) Applicant: Ming-Yuan WU, Taipei City (TW)

(72) Inventor: Ming-Yuan WU, Taipei City (TW)

(21) Appl. No.: 14/578,957

(22) Filed: Dec. 22, 2014

(30) Foreign Application Priority Data
Dec. 27, 2013 (TW) 102224607

(51) Int. Cl. H02J 7/00

(52) U.S. Cl. CPC H02J 7/0042

(57) ABSTRACT

A charger structure includes a housing. The housing has a working element, a charging connector, and a connecting interface. A power storage may be disposed. The connecting interface is configured to receive the electric power and transmit to the charging connector through the working element to supply the portable data processing device connected thereof. The housing further includes a recess to improve user convenience during charging. Moreover, the working element may include a wireless/Ethernet LAN card, a router, an anti-theft module, a battery meter, a light, an emergency light, an emergency call system, or a portable hard disk device. Therefore, the functions of the charger is enhanced.

### BACKGROUND OF THE INVENTION

1. Field of Invention

The present invention relates to a charger structure, and, more particularly, but not exclusively to a charger structure with multiple functions.

2. Related Art

Continued advancements in telecommunication technologies have made mobile phones, smartphones and other portable electronic devices very popular. And the mobile phones is more powerful, diverse, but at the same time its power consumption is more. For example, such as GPS system, playing video or audio, map application or other entertainment APP.

To charge the power of the phones, the user may use the charger device or the power bank. Both of the charger device and the power bank need specific power cables to charge. It will bother the users to take with these specific power cables, the charger device and the power bank. Therefore, there is a need to simplify the structure of the charger device and extent the functions thereof.

### SUMMARY OF THE INVENTION

The present invention overcomes the above-described and other problems and disadvantages in the prior art by providing an charger structure with multiple functions.

Accordingly, the present invention provides a charger structure, adapted to provide a working power to a portable data processing device, including a housing, and the housing includes a connecting interface, receiving an electric power; a working element, electrically connected to the connecting interface and receiving the electric power to convert the electric power into the working power; and a charging connector, electrically connected to the working element and supplying the working power to the portable data processing device.

Also, the housing may further includes a recess with a charging connector therein, and the portable data processing device is adapted to be disposed therein and electrically connected to the charging connector for supplying the working power.

Furthermore, the housing may includes a charging connector, for supplying the working power to the portable data processing device, and a movable cover plate to cover the charging connector.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIGS. 1A, 1B, 1C, 1D and 1E are perspective views of the charger structure of a first preferred embodiment of the present invention;

FIGS. 2A and 2B are perspective views of the charger structure of a second preferred embodiment of the present invention;

FIGS. 3A and 3B are perspective views of the charger structure of a third preferred embodiment of the present invention;

FIGS. 4A and 4B are perspective views of the charger structure of a fourth preferred embodiment of the present invention;

FIGS. 5A and 5B are perspective views of the charger structure of a fifth preferred embodiment of the present invention;

FIGS. 6A, 6B and 6C are perspective views of the charger structure of a sixth preferred embodiment of the present invention;

FIGS. 7A, 7B and 7C are perspective views of the charger structure of a seventh preferred embodiment of the present invention;

FIGS. 8A, 8B and 8C are perspective views of the charger structure of a eighth preferred embodiment of the present invention;

FIGS. 9A, 9B and 9C are perspective views of the charger structure of a ninth preferred embodiment of the present invention;

FIGS. 10A and 10B are perspective views of the charger structure of a tenth preferred embodiment of the present invention; and

FIGS. 11A, 11B, 11C and 11D are perspective views of the charger structure of a eleventh preferred embodiment of the present invention.

### DETAILED DESCRIPTION OF THE INVENTION

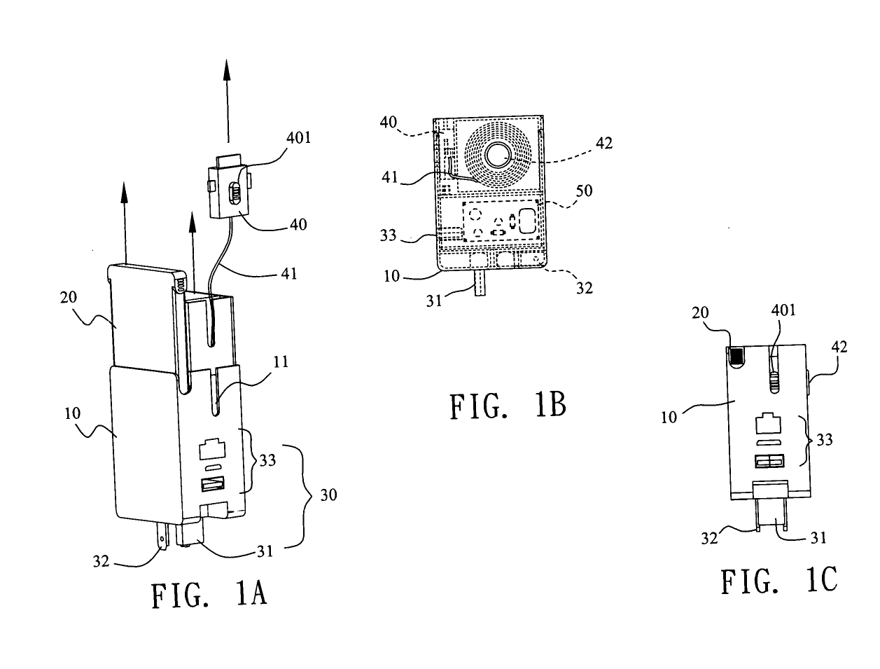

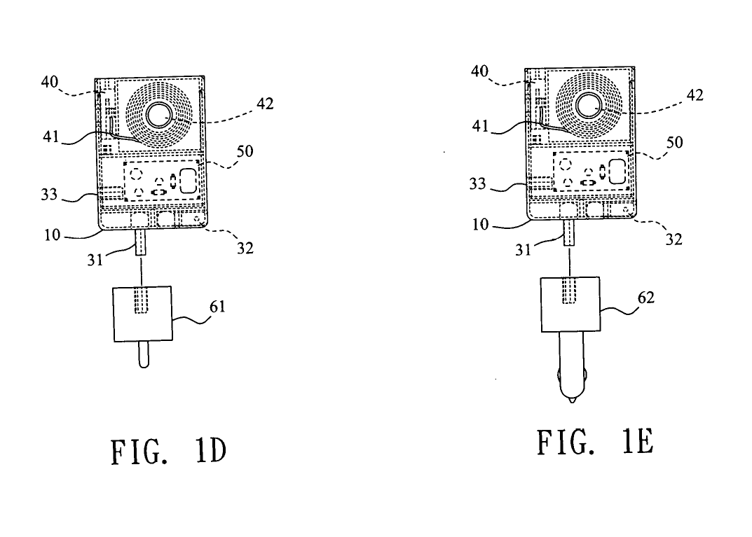

FIG. 1A is perspective view of the charger structure of a first preferred embodiment of the present invention.

The charger structure according to the invention is adapted to provide a working power to a portable data processing device. The charger structure includes a housing 10, and the housing 10 includes a connecting interface 30, a working element 50, a charging connector 40 and a power storage module 20, also see FIG. 1B. The connecting interface 30 is used to receive an electric power, and may includes an electrical plug 32 and an USB plug 31. Therefore, the electric power may be AC power or DC power. The power plug adapter 61 may be used to comply with different specifications, please refer to FIG. 1D. The car USB charger 62 may also be used to use this charger structure in vehicle, please refer to FIG. 1E. Therefore, the charger structure of this invention may be used in every place.

The working element 50 is electrically connected to the connecting interface 30 and used to receive the electric power to convert the electric power into the working power. Therefore, the working element 50 may perform such as step-down, regulated and rectifying processes. The charging connector 40 is electrically connected to the working element 50 and supplying the working power to the portable data processing device. Also, the working power may be stored in the power storage module 20. The power storage module 20 may be detachable or embedded. Therefore, the charger structure of this invention may be served as a power bank under the condition that the power supplies are lacking.

The charging connector 40 may have connector terminals with different specifications, as shown is three. Also, the charging connector 40 may be detachable form the housing 10 to replace another connector terminal with different specification. The housing 10 has a slot 11. The charging connector 40 has a push button 401 to dispose slidably therein. The the connecting interface 30 further includes connecting sockets 33 including a network socket and an USB socket, such as USB-IN ports and USB-OUT ports, please see FIG. 1C.

Please refer to FIG. 1B, the charging connector 40 includes a connector wire 41. The charging connector 40 includes a cable winding mechanism 42 to store the connector wire 41. The working element 50 may include and integrate with a wireless/Ethernet LAN card, a router, an anti-theft module, a battery meter, a light, an emergency light, an emergency call system, or a portable hard disk device. Therefore, the functions of the charger is enhanced. Take the anti-theft module for example, the portable data processing device may connect wirelessly with the the anti-theft module. If the portable data processing device is far away from the charger more than a predetermine distance, the anti-theft module may alarm the user. Also, the anti-theft module may combine with GPS system, when using in vehicle, it can be tracked when the vehicle is missed or stolen.

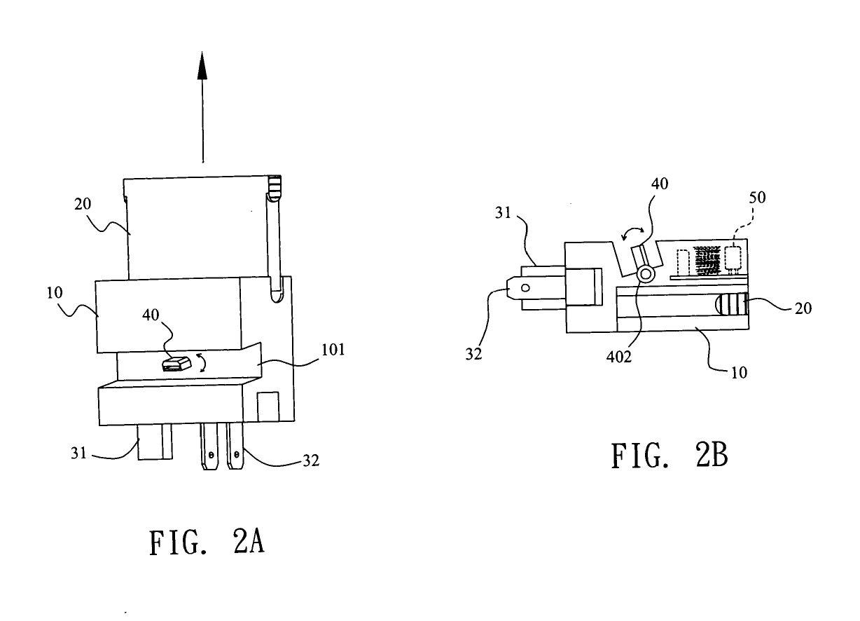

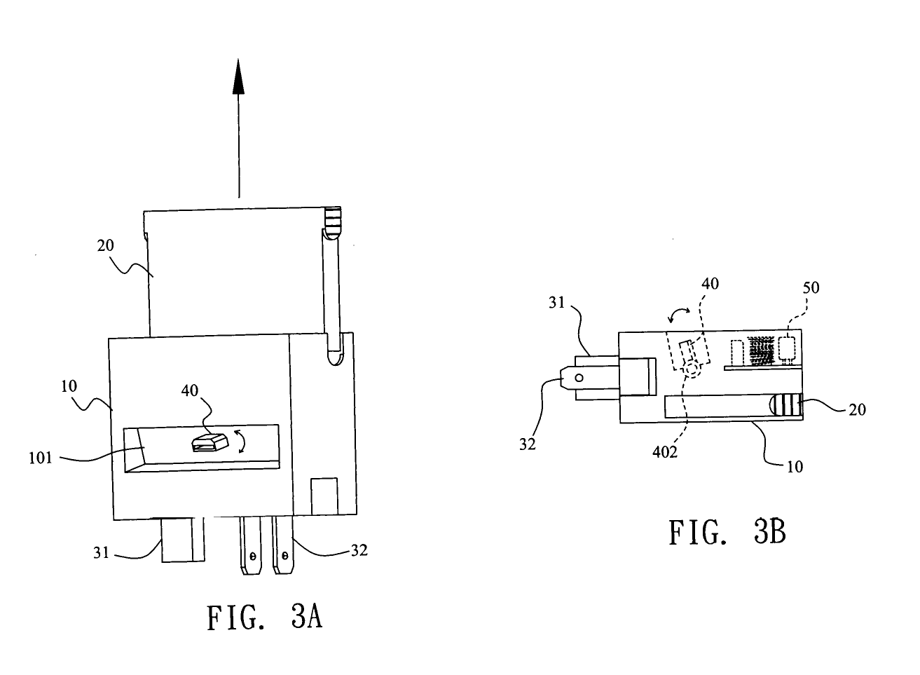

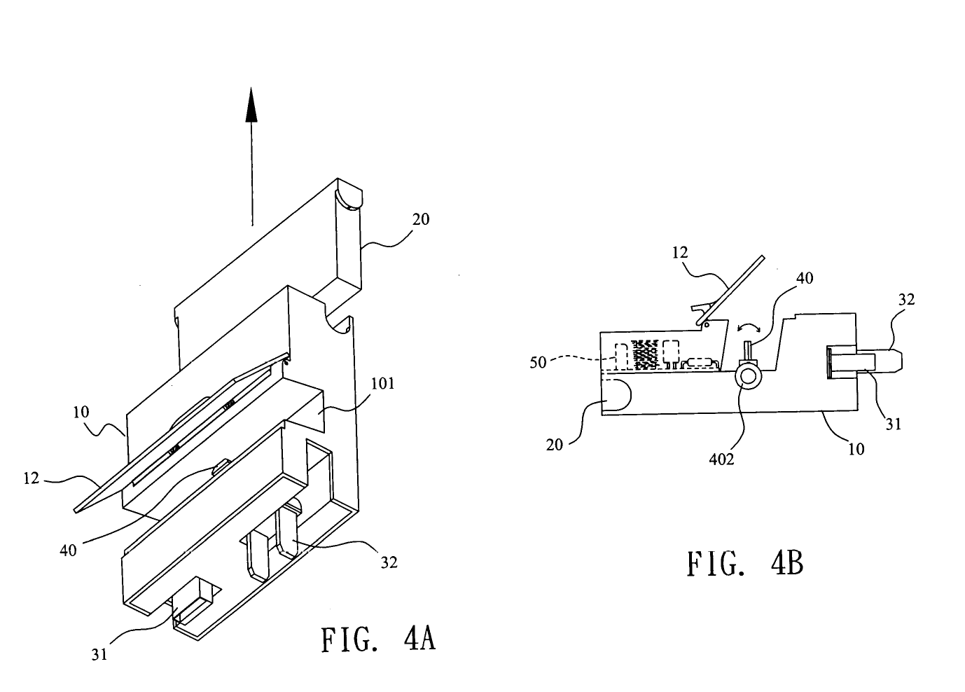

Please see FIGS. 2A and 2B, the housing 10 further includes a recess 101 with the charging connector 40 therein. The portable data processing device is adapted to be disposed therein and electrically connected to the charging connector 40 for supplying the working power. The charging connector 40 has a pivot element 402 configured to adjust the angle of the charging connector 40. Therefore, the portable data processing device may dispose in the recess 101 for charging directly. Also, the recess 101 may be larger than the portable data processing device to receive the portable data processing device together with its protection case. Please see FIGS. 3A and 3B, the recess 101 of the housing 10 in this embodiment only has one open surface to make the portable data processing device be stable when charging. Please refer to FIGS. 4A and 4B, the housing 10 further includes a cover plate 12 to cover the recess 101 and clamp the portable data processing device during charging.

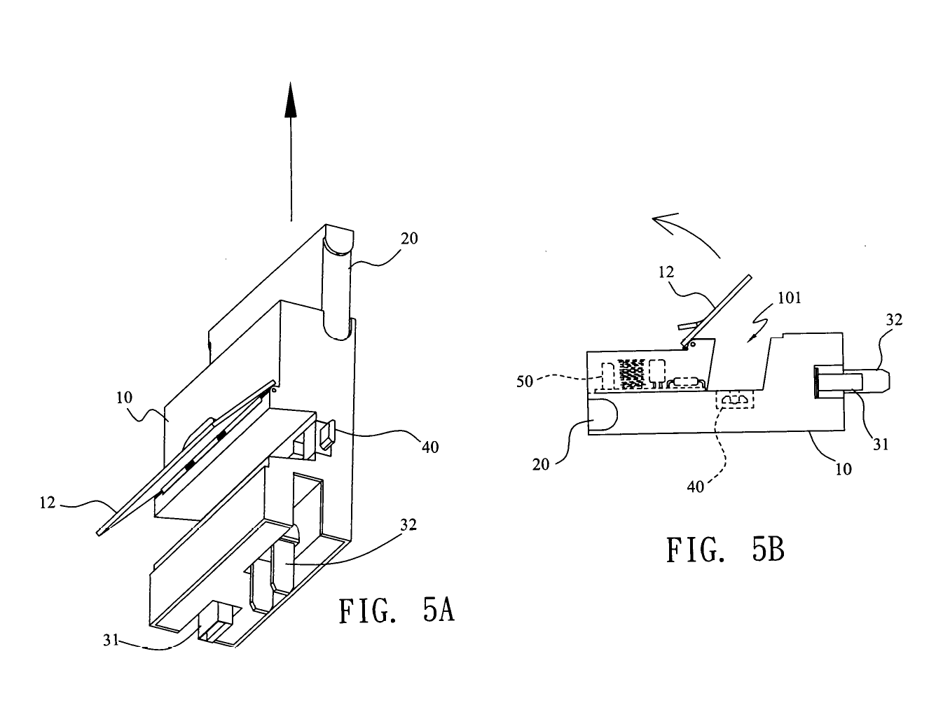

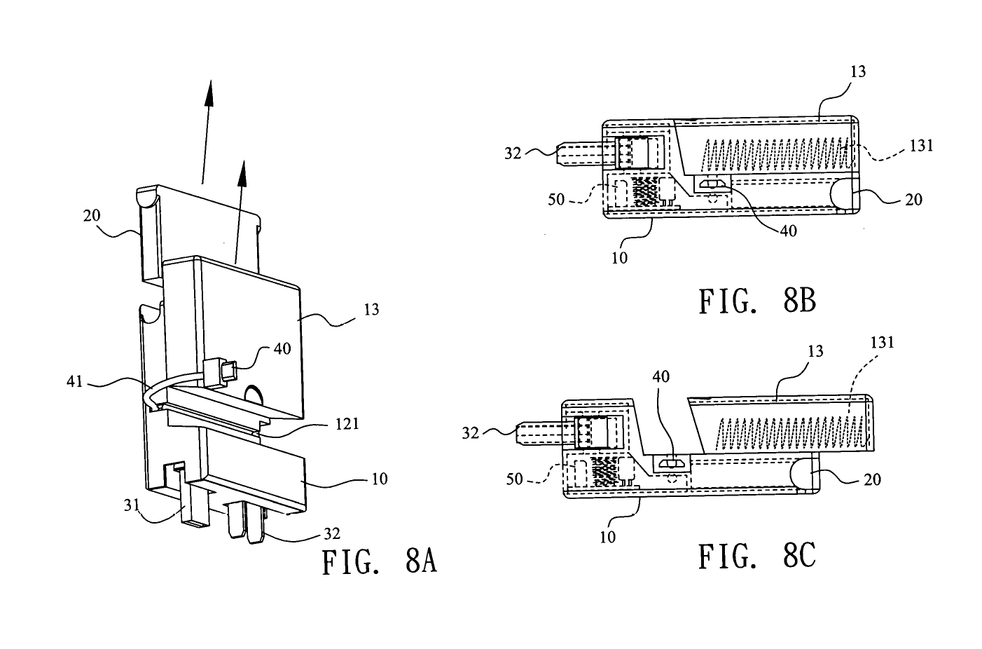

Please refer to FIGS. 5A and 5B, the charging connector 40 includes a connector wire 41. The recess 101 has a mounting slot 121 to store and place the connector wire 41, also see FIG. 8A.

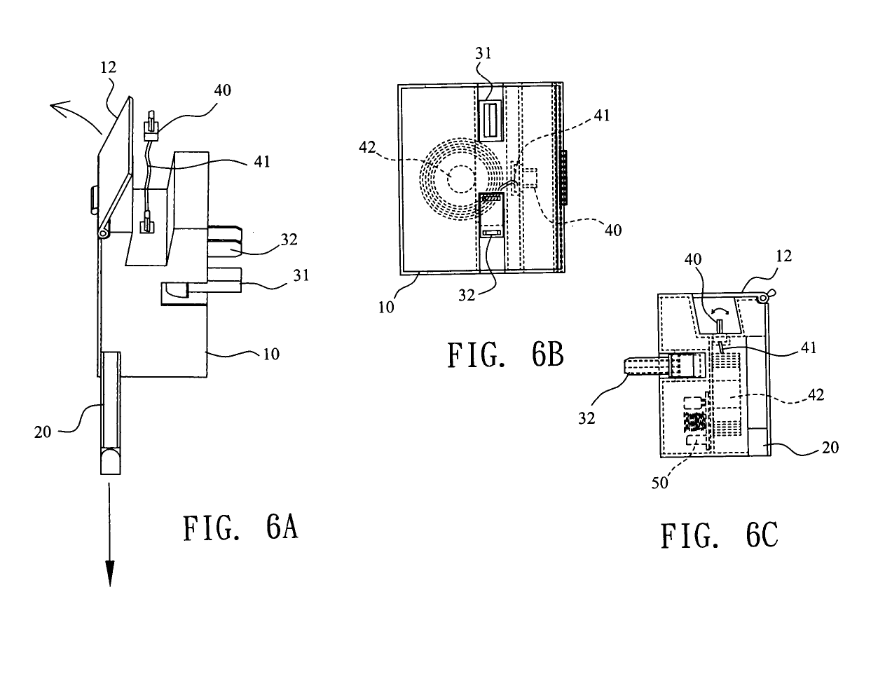

Please see FIGS. 6A, 6B and 6C, the charging connector 40 includes a cable winding mechanism 42 to wind and store the connector wire 41. When using, the cover plate 12 is opened and the charging connector 40 is pulled out to charge the portable data processing device.

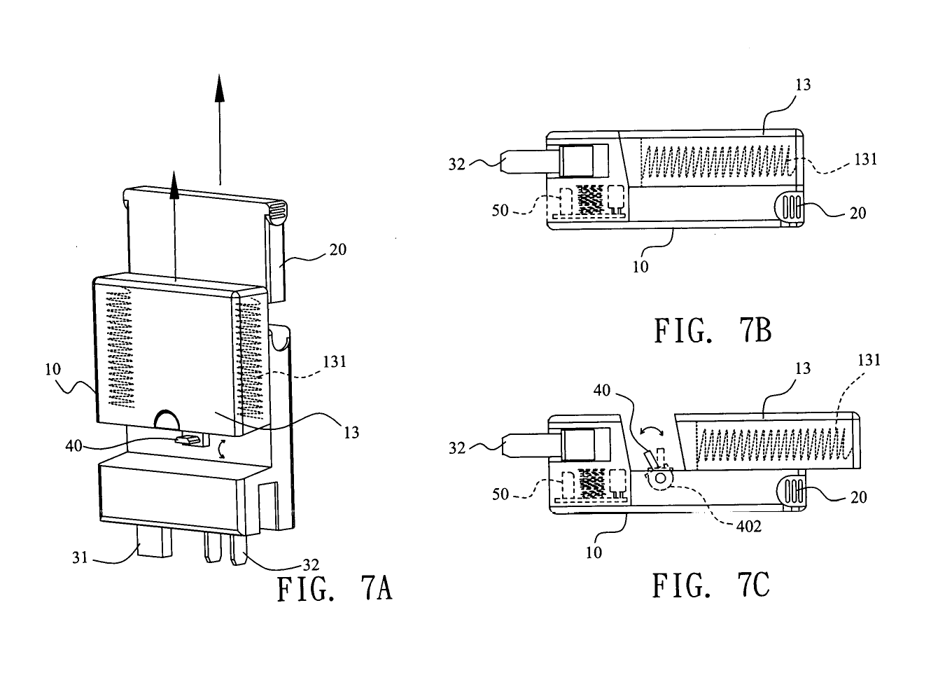

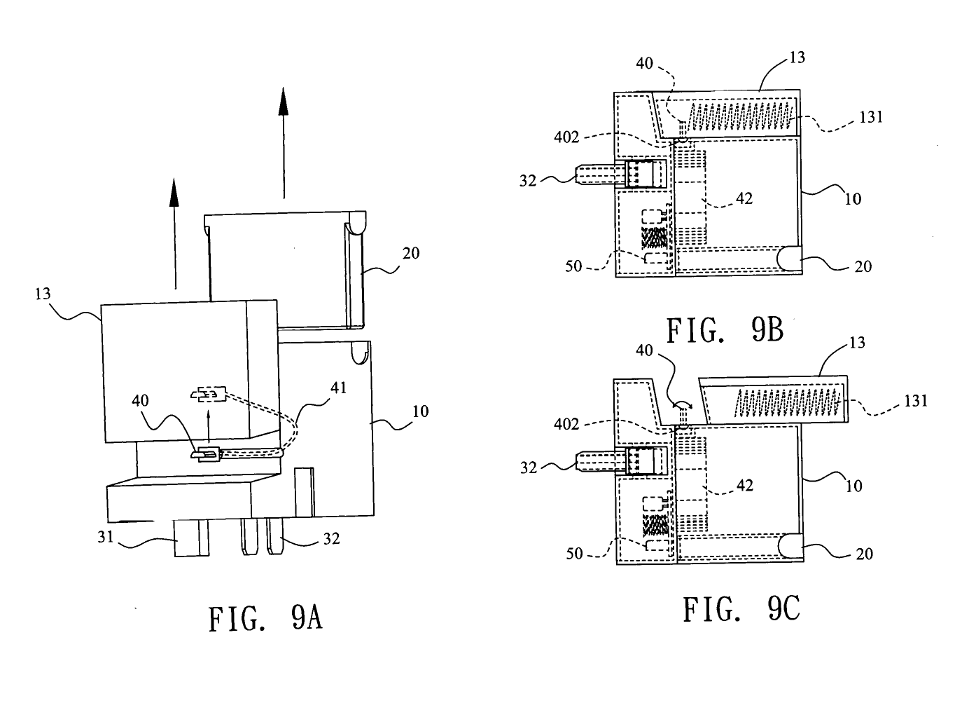

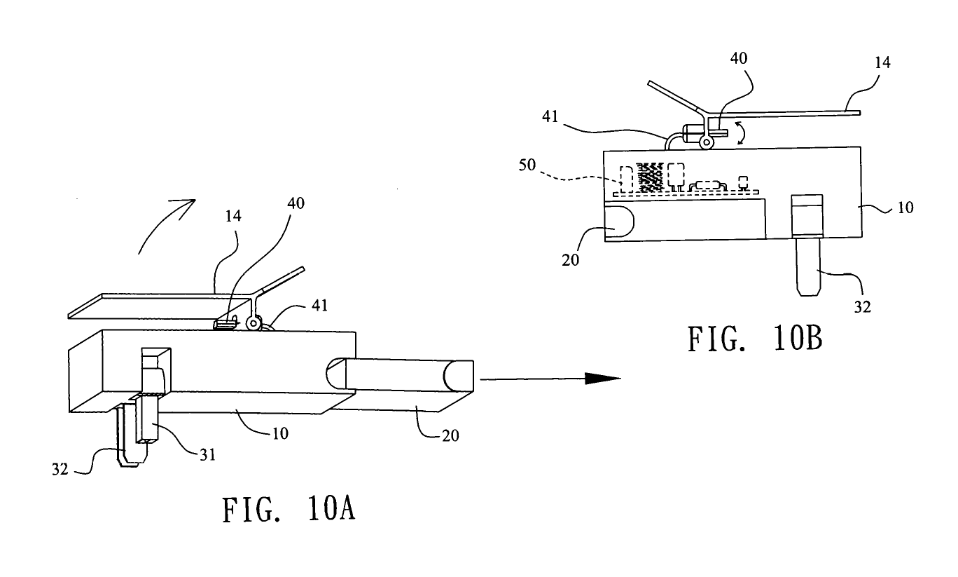

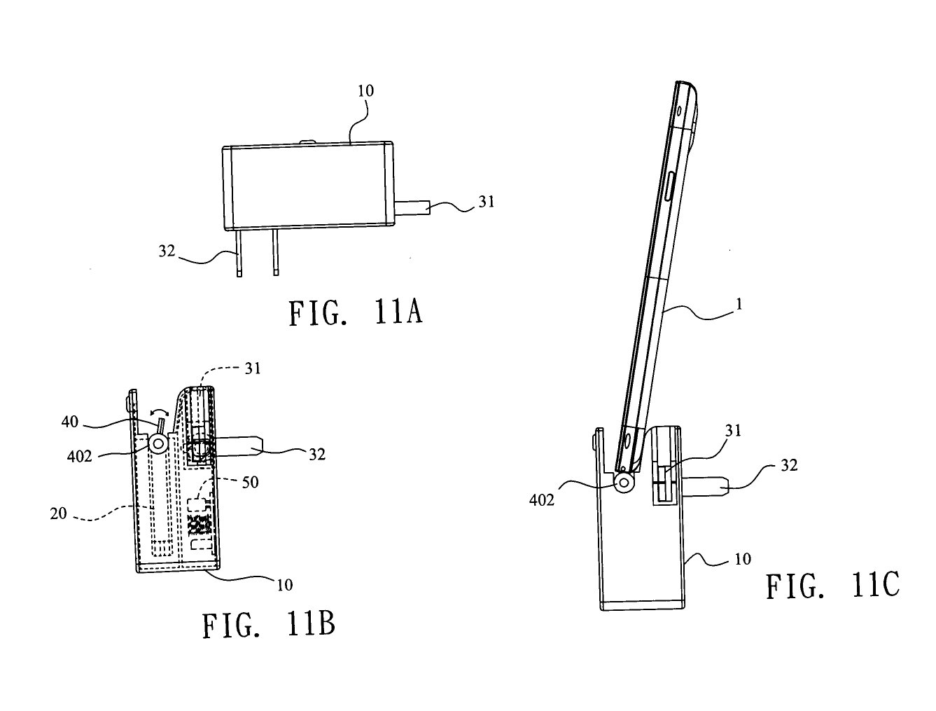

The cover plate may be a movable cover plate 13, please refer to FIGS. 7A, 7B and 7C. The movable cover plate 13 is slidable and includes an elastic element 131 for reciprocating movement. In normal condition, the movable cover plate 13 shield the charging connector 40, as shown in FIG. 7B. When in using, the movable cover plate 13 transversely, as shown in FIG. 7C, and the charging connector 40 is exposed to charge the portable data processing device. The portable data processing device is clamped by the movable cover plate 13 during charging. Please refer to FIGS. 8A. 8B and 8C, the charging connector 40 includes a connector wire 41. The recess 101 has a mounting slot 121 to store and place the connector wire 41. Please see FIGS. 9A, 9B and 9C, the charging connector 40 includes a cable winding mechanism 42 to wind and store the connector wire 41. When using, the movable cover plate 13 is opened and the charging connector 40 is pulled out to charge the portable data processing device. Please to FIGS. 10A and 10B, the movable cover plate 14 is rotatable to clamp the portable data processing device during charging

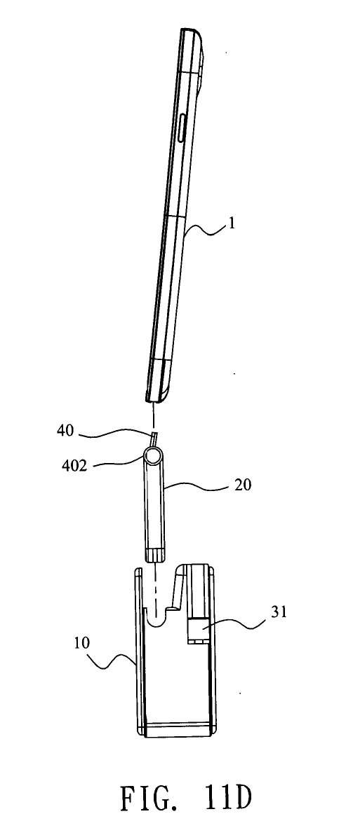

Please refer to FIGS. 11A, 11B and 11C, the power storage module 20 and the charging connector 40 are both disposed in the recess 101. The portable data processing device 1 may be installed in the recess 101 to charge directly. The power storage module 20 is detachable. Please refer to FIG. 4D, during charging, the portable data processing device 1 may be taken out together with the power storage module 20 when needed.

Therefore, the present invention provide a charger structure with multiple functions. The connecting interface may have plugs with different specifications to receive AC power or DC power. The working element may include and integrate with a wireless/Ethernet LAN card, a router, an anti-theft module, a battery meter, a light, an emergency light, an emergency call system, or a portable hard disk device. Therefore, the functions of the charger is enhanced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A charger structure, adapted to provide a working power to a portable data processing device, including a housing, and the housing comprising:
a connecting interface, receiving an electric power;
a working element, electrically connected to the connecting interface and receiving the electric power to convert the electric power into the working power; and
a charging connector, electrically connected to the working element and supplying the working power to the portable data processing device.

2. The charger structure of claim 1, further comprising a power storage module to store the working power.

3. The charger structure of claim 2, wherein the power storage module is detachable.

4. The charger structure of claim 1, wherein the charging connector is detachable from the housing.

5. The charger structure of claim 1, wherein the connecting interface includes an electrical plug and an USB plug.

6. The charger structure of claim 1, wherein the connecting interface further comprising connecting sockets including a network socket and an USB socket.

7. A charger structure, including a housing, and the housing comprising a connecting interface for receiving an electric power and a working element for receiving the electric power to convert the electric power into the working power to provide to a portable data processing device, the housing further comprising:
a recess with a charging connector therein, and the portable data processing device is adapted to be disposed therein and electrically connected to the charging connector for supplying the working power.

8. The charger structure of claim 7, further comprising a power storage module to store the working power.

9. The charger structure of claim 8, wherein the charging connector is disposed on the power storage module and the power storage module is detachable from the recess.

10. The charger structure of claim 7, wherein the charging connector has a pivot element configured to adjust an angle of the charging connector.

11. The charger structure of claim 7, wherein the charging connector includes a connector wire.

12. The charger structure of claim 11, wherein the charging connector includes a cable winding mechanism to store the connector wire.

13. The charger structure of claim 11, wherein the slot has a mounting slot to store the connector wire.

14. The charger structure of claim 7, wherein the housing further comprising a cover plate to cover the recess and clamp the portable data processing device during charging.

15. A charger structure, including a housing, and the housing comprising a connecting interface for receiving an electric power and a working element for receiving the electric power to convert the electric power into the working power to provide to a portable data processing device, the housing further comprising:
a charging connector, for supplying the working power to the portable data processing device, and a movable cover plate to cover the charging connector.

16. The charger structure of claim 15, further comprising a power storage module to store the working power.

17. The charger structure of claim 15, wherein the charging connector has a pivot element configured to adjust an angle of the charging connector.

18. The charger structure of claim 15, wherein the charging connector includes a connector wire.

19. The charger structure of claim 18, wherein the charging connector includes a cable winding mechanism to store the connector wire.

20. The charger structure of claim 15, wherein the movable cover plate includes an elastic element for reciprocating movement.

21. The charger structure of claim 15, wherein the movable cover plate is slidable to clamp the portable data processing device during charging.

22. The charger structure of claim 15, wherein the movable cover plate is rotatable to clamp the portable data processing device during charging.
